(19) United States
(12) Patent Application Publication
(10) Pub. No.: US 2015/0227968 A1
(43) Pub. Date: Aug. 13, 2015

(54) SYSTEMS AND METHODS FOR CREATING AND DELIVERING DIGITAL ADVERTISEMENTS IN A DELIVERY AD NETWORK

(71) Applicant: FedEx Corporate Services, Inc., Collierville, TN (US)

(72) Inventors: William S. MURPHY, Jr., Germantown, TN (US); Kenneth L. Milman, Memphis, TN (US); John E. Holmes, Memphis, TN (US)

(21) Appl. No.: 14/615,492

(22) Filed: Feb. 6, 2015

Related U.S. Application Data
(60) Provisional application No. 61/937,258, filed on Feb. 7, 2014.
(60) Provisional application No. 61/937,231, filed on Feb. 7, 2014.

(51) Int. Cl. G06Q 30/02

(52) U.S. Cl. CPC G06Q 30/0251; G06Q 30/0276

(57) ABSTRACT

Systems and methods may create and deliver digital advertisements in a delivery ad network. In one implementation, a method may include receiving, by a processor, a digital advertisement. The digital advertisement may include data associated with a product. The method may also include linking, by the processor, the digital advertisement to the product. The linking may include associating a unique identifier associated with the digital advertisement to a unique identifier associated with the product. The method may further include preparing, by the processor, the digital advertisement for delivery. The preparation may include determining a destination device associated with a user. The method may further include transmitting, by the processor, the digital advertisement to the destination device associated with the user, and the transmission may be triggered by a predetermined set of rules.

### CROSS REFERENCES TO RELATED APPLICATIONS

This application claims priority under 35 U.S.C. §119 to U.S. Provisional Application No. 61/937,231, filed on Feb. 7, 2014, and entitled “Delivery Ad Network,” and U.S. Provisional Application No. 61/937,258, filed on Feb. 7, 2014, and entitled “Digital Delivery.” The aforementioned applications are incorporated herein by reference in their entirety.

### TECHNICAL FIELD

The present disclosure relates generally to systems and methods for creating and delivering digital advertisements in a delivery ad network. More particularly, the disclosure relates to systems and methods for delivery digital advertisements and other digital communications at any point before, during or after delivery of a product.

### BACKGROUND

Advances in ecommerce have contributed to an increase in the volume and complexity of commercial activity. Through ecommerce, businesses have found new channels for receiving, routing and distributing different products or shipments. The increase in ecommerce has also resulted in complexity in the types and amount of digital information related to the products delivered to customers or other businesses. This increase in volume and complexity has created a need for businesses to creatively receive, route and distribute digital advertisements related to particular physical products.

In addition, the increase in ecommerce has resulted in an increased need to creatively use unique information available through package delivery networks, such as shipment specific information, to provide additional services to users and to creatively target digital advertisements to users before, during or after delivery of shipments.

Further, sellers of products or third party producers of related products may find it increasingly difficult to deliver specific targeted digital advertisements or communications to the recipients of the products. For example, such senders or third parties may find it difficult to customize the types of digital advertisements and communications delivered to specific recipients based on other business rules or relationships.

Thus, improvements in techniques for linking physical packages with associated digital advertisements and communications are desirable. In particular, there is an increasing need for improved techniques that allow customers to view digital advertisements and communications associated with the physical packages or shipments delivered.

### SUMMARY

Consistent with discloses embodiments, systems and methods intelligently create and deliver digital advertisements in a delivery ad network, including intelligently linking digital advertisements to products, updating rules, logic and triggers controlling the delivery of the digital advertisements, and transmitting or delivering digital advertisements associated with products.

Consistent with a disclosed embodiment, a computer-implemented method for creating and delivering digital advertisements in a delivery ad network may comprise receiving, by a processor, a digital advertisement. The digital advertisement may include data associated with a product. The method may also comprise linking, by the processor, the digital advertisement to the product. The linking may include associating a unique identifier associated with the digital advertisement to a unique identifier associated with the product. The method may additionally comprise preparing, by the processor, the digital advertisement for delivery, wherein the preparation includes determining a destination device associated with a user. The method may further include transmitting, by the processor, the digital advertisement to the destination device associated with the user. The transmission may be triggered by a predetermined set of rules.

Consistent with a disclosed embodiment, a system for creating and delivering digital advertisements in a delivery ad network may include at least one processor and a memory device storing instructions executable by the at least one processor to perform operations. The operations may comprise receiving a digital advertisement, and the digital advertisement may include data associated with a product. The operations may further include linking the digital advertisement to the product. The linking may include associating a unique identifier associated with the digital advertisement to a unique identifier associated with the product. The operations may further comprise preparing the digital advertisement for delivery, and the preparation may include determining a destination device associated with a user. The operations may further comprise transmitting the digital advertisement to the destination device associated with the user, and the transmission may be triggered by a predetermined set of rules.

Consistent with yet another disclosed embodiment, a non-transitory computer readable medium is disclosed, the medium storing instructions that, when executed by at least one processor, cause the at least one processor to execute a computer-implemented method for creating and delivering digital advertisements in a delivery ad network. The method may include receiving a digital advertisement. The digital advertisement may include data associated with a product. The method may further include linking the digital advertisement to the product. The linking may include associating a unique identifier associated with the digital advertisement to a unique identifier associated with the product. The method may further include preparing the digital advertisement for delivery. The preparation may include determining a destination device associated with a user. The method may further include transmitting the digital advertisement to the destination device associated with the user. The transmission may be triggered by a predetermined set of rules.

Both the foregoing general description and the following detailed description are exemplary and are intended to provide further explanation of the disclosed embodiments.

### BRIEF DESCRIPTION OF THE DRAWINGS

The accompanying drawings, which are incorporated in and constitute a part of this specification, illustrate various implementations and aspects of the disclosed embodiments. In the drawings:

FIG. 1 is a block diagram of an exemplary system for creating and delivering digital advertisements in a delivery ad network consistent with a disclosed embodiment.

FIG. 2 illustrates an exemplary flowchart of an exemplary process for creating and delivering digital advertisements in a delivery ad network consistent with disclosed embodiments.

FIG. 3 depicts an exemplary digital advertisement of an exemplary system for creating and delivering digital advertisements in a delivery ad network consistent with disclosed embodiments.

FIG. 4 depicts an exemplary recipient device used in an exemplary system for creating and delivering digital advertisements in a delivery ad network consistent with disclosed embodiments.

FIG. 5 depicts an exemplary process for creating and delivering digital advertisements in a delivery ad network consistent with disclosed embodiments.

FIG. 6 depicts another exemplary process for creating and delivering digital advertisements in a delivery ad network consistent with disclosed embodiments.

FIG. 7 depicts a block diagram of an exemplary computer system consistent with disclosed embodiments.

### DETAILED DESCRIPTION

The following detailed description refers to the accompanying drawings. Wherever possible, the same reference numbers are used in the drawings and the following description to refer to the same or similar parts. While certain embodiments are described herein, modifications, adaptations and other implementations are possible, without departing from the spirit and scope of the disclosed embodiments. For example, substitutions, additions or modifications may be made to the components illustrated in the drawing, and the exemplary methods described herein may be modified by substituting, reordering, or adding steps to the disclosed methods. Accordingly, the following detailed description is not limiting. Instead, the proper scope is defined by the appended claims.

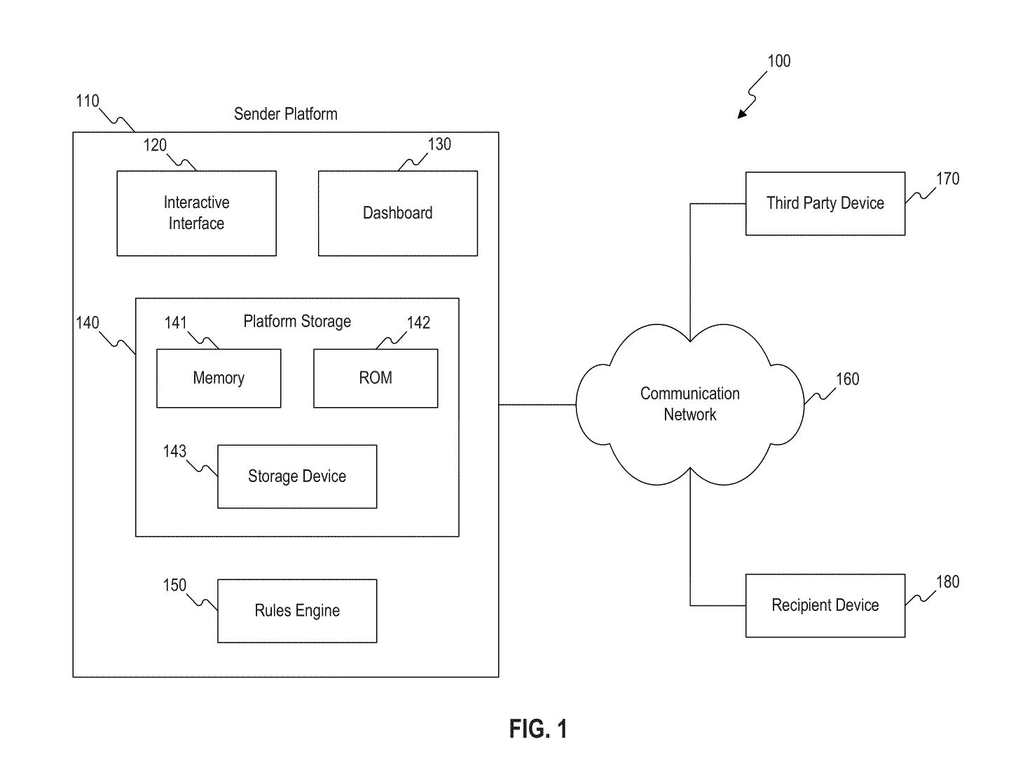

FIG. 1 is a block diagram of an exemplary system for creating and delivering digital advertisements in a delivery ad network, consistent with disclosed embodiments. System 100 may include a sender platform 110, a communication network 160, a third party device 170 and a recipient device 180. Sender platform 110 may include an interactive interface 120, a dashboard 130, platform storage 140, and rules engine 150. Platform storage 140 may include memory 141, ROM 142, and storage device 143.

Sender platform 110 may be implemented using a server, desktop computer, workstation, network computer, laptop computer, mainframe, Wi-Fi device, web-enabled cellular telephone, wearable computer or other similar microcomputer-based workstation or network device. Sender platform 110 may comprise any appropriate type of computing or computer operating devices, such as hand-held devices, multiprocessor systems, microprocessor-based or programmable sender electronic devices, minicomputers, mainframe computers, and the like. Sender platform 110 may also be practiced in distributed computing environments where tasks are performed by remote processing devices. Furthermore, sender platform 110 may comprise a mobile terminal, such as a smart phone, a cellular telephone, a cellular telephone utilizing wireless application protocol (WAP), PDA, intelligent pager, portable computer, a hand held computer, a conventional telephone, or a facsimile machine.

Interactive interface 120 may include a single interactive portal allowing for real-time performance of various tasks, viewing of data, or providing access to sub-interfaces on sender platform 110. Interactive interface 120 may include a dynamic Web page using hypertext markup language (“HTML”), and may use other aspects of TCP/IP including the hypertext transfer protocol (“HTTP”); the user datagram protocol (“UDP”); the file transfer protocol (“FTP”); and the extensible markup language (“XML”). Interactive interface 120 may be accessible via the Internet. Further, interactive interface 120 may be interactive, allowing for users to customize the interface, input information, manipulate categories of data, and dynamically view the results of their actions.

Interactive interface 120 may comprise other digital channels of communications including native or installed applications on a desktop computer, laptop computer, mobile computing device, wearable computing device, and other types of computing devices. Interactive interface 120 may be mobile or web based.

Dashboard 130 may include a portal allowing for viewing of summaries of data including user preference data, user historical activity, past orders and other such information stored on sender platform 110. Dashboard 130 may store interactive responses from a recipient or third party and allow future access to these responses. Dashboard 130 may also allow for aggregation and analysis of responses from multiple recipients or third parties. The data may be stored in dashboard 130 for a predetermined period of time.

Dashboard 130 may include a dynamic Web page using hypertext markup language (“HTML”), and may use other aspects of TCP/IP including the hypertext transfer protocol (“HTTP”); the user datagram protocol (“UDP”); the file transfer protocol (“FTP”); and the extensible markup language (“XML”). Dashboard 130 may be accessible via the Internet. Further, dashboard 130 may be interactive, allowing for users to customize the display, input information, manipulate categories of data, and dynamically view the results of their actions.

Platform storage 140 may comprise devices employing hardware- and/or software-based logic to store instructions, media, signaling data, measurement values, and/or other types of information related to delivery of digital advertisements. For example, platform storage 140 may be implemented in a memory 140, a ROM 142, or a storage device 143.

Platform storage 140 may contain databases including specialized databases as would be recognized by one skilled in the art. Alternatively, the information stored in platform storage 140 may be maintained in structured or unstructured form using a standard file, spreadsheet, or other data assemblage for information storage and retrieval, as is known in the art.

Rules engine 150 may be a computing platform that includes a hardware framework and/or software architecture. Rules engine 150 may include modules integrated with other components of sender platform 110. Rules engine 150 may also include one or more components with access to functionality available through server platform 110 and data stored in platform storage 140.

Rules engine 150 may contain one or more rules represented, for example, as logic (for example, application logic) and triggers (for example, database triggers). The logic and triggers may comprise different sets of rules regarding when the delivery or transmission of the digital advertisement should be initiated. For example, the logic and triggers may comprise a set of rules that determine, for example, who receives particular digital content, when the digital content should be provided, where and how the digital content is accessible by recipients or third parties, how long the digital content should be offered, and any other conditions which help control distribution of digital content.

In some embodiments, the logic and triggers may comprise a set of rules associated with marketplace mechanics. For example, the logic and triggers may comprise rules that trigger delivery of digital advertisements based on market or demand based characteristics, delivery characteristics, location, recipient demographics, shipping history, product details such as product type, and digital advertisement placement visibility. For example, the rules may trigger delivery of digital advertisements based on variation in pricing characteristics such as flat pricing, time based pricing, or variable pricing based on market changes.

Rules engine 150 may implement the logic and triggers as computer programs or modules of computer program instructions that are encoded on a computer storage media.

In one embodiment, rules engine 150 may be configured to trigger an action by one or more modules in sender platform 110, such as initiating the transmission or delivery of a digital advertisement. Rules engine 150 may assess one or more conditional relationships based on information stored in platform storage 140. The execution of a rule may trigger the execution of a predetermined set of additional rules.

Communication network 160 may comprise any data network capable of transmitting or transferring information such as local area networks (LANs), wide area networks (WANs) such as the Internet, and/or metropolitan area networks (MANs). Communication network 160 may operate using any appropriate network protocol, such as asynchronous transfer mode (ATM), Internet protocol (IP), Synchronous Digital Hierarchy (SDH), or synchronous optical network (SONET). Communication network 160 may comprise network devices, such as gateways, servers, routers, switches, or firewalls. Communication network 160 may be a wireless network using free-space optical and/or radio frequency transmission paths, or may be a hardwired network using wired conductors and/or optical fibers. Implementations of networks and/or devices operating on networks described herein are not limited to any particular data type, and/or protocol.

LAN or WAN networking environments are commonplace in offices, enterprise-wide computer networks, intranets, and the Internet, and are known by those skilled in the art. When a LAN is used as communication network 160, a network interface may be used for interconnection. When communication network 160 is implemented in a WAN networking environment, such as the Internet, an internal or external modem or other means for establishing communications over the WAN may be used. Further, data sent over communication network 160 may be encrypted to ensure data security by using known encryption/decryption techniques.

Communication network 160 may comprise a wireless communications system or a combination of wireline and wireless may comprise communication network 160. “Wireless” generally refers to radio transmission via the airwaves, such as cellular, microwave, satellite, packet radio and spread spectrum radio. However, various other communication techniques may be used to provide wireless transmission, including infrared line-of-sight. Wireless data may include, but is not limited to, voice data, paging, text messaging, e-mail, Internet access, and other specialized data.

In other embodiments, communication network 160 may be implemented using a network, such as the Public Switched Telephone Network. Alternatively, communication network 160 may be implemented on a voice-over-broadband network, such as a network using VoIP technology. Additionally, in other embodiments, communication network 160 may be a video over broadband network, such as, for example, a network for providing two-way video communications. In another example, communication network 160 may be a wireless broadband network, such as, for example, a network using WiFi (for example, IEEE 802.11(b) and/or (g)). In yet another example, communication network 160 may be a wireless voice network(s), such as, for example, a cellular or third-generation cellular network. In addition, communication network 160 may be implemented using any one or a combination of the above-described technologies, consistent with the disclosed embodiments.

Third party device 170 may comprise any device capable of sending information to another device. For example, third party device 170 may include various types of computing devices such as a desktop computer, a laptop computer, a client, a server, a pager, a personal digital assistant (PDA), or another computation or communication device. Third party device 170 may also include devices such as a plain old telephone system (POTS) handset, an Integrated Services Digital Network (ISDN) device, a cellular telephone device, a voice over Internet Protocol (VoIP) device, or different types of telephone devices such as a web-enabled cellular device or an Internet Protocol (IP) telephone. Third party device 170 may include a courier device, a box sensor, a phone or a wearable computing device (for example, Google Glass).

In one embodiment, third party device 170 may be implemented using any device capable of accessing the Internet, such as a general purpose computer or personal computer equipped with a modem. In one embodiment, third party device 170 may use instant messaging (“IM”) to communicate with either the sender platform 110 or recipient device 180. In addition, third party device 170 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Third party device 170 may establish a connection with either sender platform 110 or recipient device 180 directly or indirectly, for example, by transmitting data to an intermediate device that may subsequently forward the data to either sender platform 110 or recipient device 180 on behalf of third party device 170. During the connection, third party device 170 may exchange, with sender platform 110 or recipient device 180, a variety of media information such speech, video, text, images or numerical data. Third party device 170 may exchange such media directly or indirectly with either sender platform 110 or recipient device 180. Further, third party device 170 may transmit the data over the same or over different communication channels. In other aspects, third party device 170 may send analog and/or digital data and/or media, including non-packet-based and/or packet based information.

Recipient device 180 may comprise any device capable of sending information to another device. For example, recipient device 180 may include various types of computing devices such as a desktop computer, a laptop computer, a client, a server, a pager, a personal digital assistant (PDA), or another computation or communication device. Recipient device 180 may also include devices such as a plain old telephone system (POTS) handset, an Integrated Services Digital Network (ISDN) device, a cellular telephone device, a voice over Internet Protocol (VoIP) device, or different types of telephone devices such as a web-enabled cellular device or an Internet Protocol (IP) telephone. Recipient device 180 may include a courier device, a box sensor, a phone or a wearable computing device (for example, Google Glass).

In one embodiment, recipient device 180 may be implemented using any device capable of accessing the Internet, such as a general purpose computer or personal computer equipped with a modem. In one embodiment, recipient device 180 may use instant messaging (“IM”) to communicate with either the sender platform 110 or third party device 170. In addition, recipient device 180 may use other aspects of TCP/IP including the hypertext transfer protocol (“HTTP”); the user datagram protocol (“UDP”); the file transfer protocol (“FTP”); the hypertext markup language (“HTML”); and the extensible markup language (“XML”).

Recipient device 180 may establish a connection with either the sender platform 110 or third party device 170 directly or indirectly, for example, by transmitting data to an intermediate device that may subsequently forward the data to either the sender platform 110 or third party device 170 on behalf of recipient device 180. During the connection, recipient device 180 may exchange, with either the sender platform 110 or third party device 170, a variety of media information as part of the data, such speech, video, text, images or numerical data. Recipient device 180 may exchange such media directly or indirectly with either the sender platform 110 or third party device 170. Further, recipient device 180 may transmit the data over the same or over different communication channels. In other embodiments, recipient device 180 may send analog and/or digital data and/or media, including non-packet-based and/or packet based information.

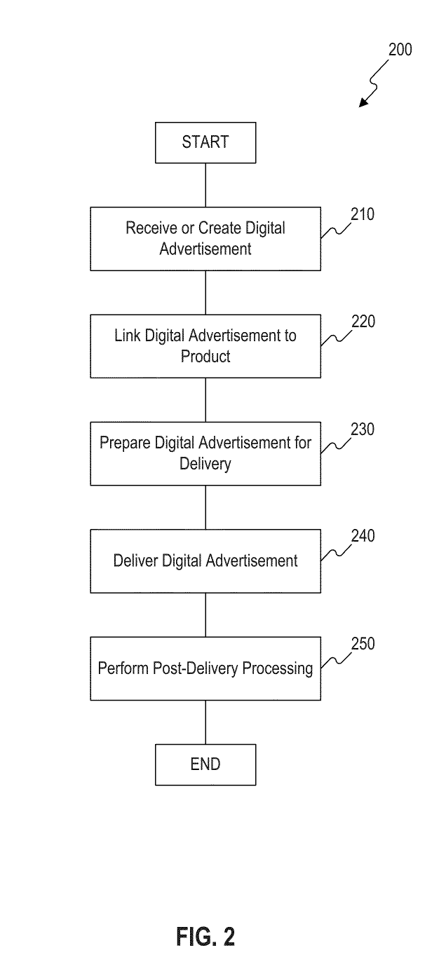

FIG. 2 illustrates an exemplary flowchart of an exemplary process 200 for creating and delivering digital advertisements in a delivery ad network consistent with a disclosed embodiment. In particular, process 200 provides a method for creating and delivering digital advertisements related to a product or shipment.

In Step 210, sender platform 110 may create, request, or receive a digital advertisement. For example, sender platform 110 may request a digital advertisement from third party device 170 and receive a digital advertisement from third party device 170. Sender platform 110 may create a digital advertisement associated with a product shipped to a recipient. Sender platform 110 may also retrieve a digital advertisement previously created or received and stored in the platform storage 140.

A digital advertisement may include any digital media such as email, text, documents, images, picture files, video files, sound files, data fields, pdf files, web-displayed content, messages on mobile apps, or other types of media items or digital files. The digital advertisement may be of different formats and may include pre-defined forms, pre-structured data, input-structured data, or unstructured data.

The digital advertisement may also include application files such as games and apps, application programming interface (API), or other machine-to-machine data. The API may comprise one or more detailed specifications for a combination of one or more functions, data structures, routines, variables, object classes, or other standardized interfaces. The API may be generated based on an operating interface standard such as Portable Operating System Interface (POSIX) or may be specifically defined by the sender or third party. Machine-to-machine communication may be used by any “smart” computing device, including any networked computing device containing autonomous computing software enabling the device to receive data, interpret the data, and make appropriate decisions or perform appropriate actions.

The digital advertisement may include a user guide, instruction manual, a video of how to install or use a product, or an email cross-selling other products such as similar products or complementary products. The digital advertisements may also include an interactive form such as product registration, user experience or other types of surveys, feedback forms and other types of interactive media. The digital advertisement may also include data related to 3D printing including electronic media files including 3D image or print files. For example, the digital advertisement may include licenses, warranties, digital invoices, digital packing slips, offers, discounts, marketing communications, product information, and complementary or similar product promotions. The digital advertisement may include limited use or limited duration items such as coupons with expiry dates, or limited time offer promotions.

The digital advertisement may be created, received or requested from a sender or a third party. For example, the digital advertisement may include cross-sell promotions by the sender or third party for other types of products, such as complementary or similar products. The cross-sell promotions may include targeted offers for products and services connected to, for example, a particular product or a package delivery event.

In another example, the digital advertisement may include data associated with a product or other metadata such as supply chain information, product description, pricing, handling and storage information, geolocation or geofencing information, history log information, inventory management information, and other types of metadata related to the supply chain or product. The information may include details on the supply chain history from shipment dispatch by the originator in the supply chain to product receipt by downstream business or recipient. The digital advertisement may include, for example, notes added by various parties in the supply chain regarding any unique details on the product or shipment's storage and handling procedures, or any damages or anomalies noted in the shipment.

In some embodiments, the digital advertisement may have a unique identifier associated with it. The unique identifier may be automatically generated by sender platform 110, or may be generated based on the unique identifier of the product associated with the digital advertisement. The unique identifier may also be generated based on the content or type of content in the digital advertisement.

The sender, recipient, or third party could be individual user, a business, or other type of organization involved in any step in the supply chain of either a physical or digital product or the digital advertisement. For example, the sender recipient or third party may be an organization that conducts any type of ecommerce activity.

In another embodiment, the sender platform 110 may create a digital advertisement based on the product associated with the digital advertisement. The sender platform 110 may create a digital advertisement based on product category, delivery location, delivery time, recipient identification and demographic information, tracking number, product information or other related information.

In step 220, sender platform 110 may create a link between the digital advertisement and the product. The link may be to a physical product, shipment or package. For example, a sender or third party using sender platform 110 may manually or automatically connect a digital advertisement to a product by using the tracking number, another unique identifier of the product or shipment, or other information unique to the product or shipment.

The sender platform 110 may create different types of links. For example, the link may be established between a unique digital advertisement (with a unique identifier) and a unique product (with a unique identifier), or between a unique digital advertisement to one or more sets of predetermined products, or between one or more sets of digital advertisements and a unique product, or between one or more types of digital advertisements and one or more types of products. The link may be established based on unique shipping information combined with other information that allows for targeting of specific types of digital advertisements to recipients of specific types of products or shipments.

In some embodiments, the link may be based on sender information, product category, delivery location, delivery time, recipient identification and demographic information, tracking number, product information, and/or digital advertisement information.

Sender platform 110 may optimize the link between the digital advertisement and product based on shipment or product specific information or contextual metadata, such as consignee details, package content details, environmental information, and unstructured data such as comments and pictures provided by sender, recipient or third party.

In some embodiments, sender platform 110 may optimize the link between the digital advertisement and product based on historical information about the recipient shipping behavior including previous items delivered, frequency of items delivered, previous senders of shipments and similar historical metadata.

The link between the digital advertisement and the product may be customized. For example, a recipient or third party may customize, using interactive interface 120 or the dashboard 130, the types of digital advertisements of interest based on the recipient's and/or third party's preferences. The recipient and/or third party may also associate one or more types of digital advertisements to one or more types of products.

In some embodiments, the third party may transmit digital advertisements to sender platform 110, using the third party device 170. The digital asses may be associated with a particular product type, product identifier, tracking number, or other identifier associated with a product or shipment. The third party's preferences may be stored in the dashboard 130 for future reference. Further, the third party may access the stored preferences in the dashboard 130 and modify, update, or make any relevant changes or customizations. The third party may have access to all the advertisement delivery capabilities, communication, triggering, and other mechanism of sender platform 110.

In Step 230, sender platform 110 may prepare the digital advertisement for delivery. For example, sender platform 110 may automatically format the digital advertisement based on predefined rules. In another example, sender platform 110 may format the digital advertisement based on the type of digital advertisement to be transmitted. For example, where the digital advertisement is a digital media file, the sender platform 110 may format the digital advertisement according to the means of transmission of the digital advertisement. The digital advertisement may be formatted into an email, or could be formatted into an interactive web form with a corresponding link. In another example, the digital advertisement may be formatted into the appropriate API or machine-to-machine data format required.

In another embodiment, sender platform 110 may determine one or more destination devices associated with the recipient. Sender platform 110 may determine the destination address associated with recipient device 180. As another example, sender platform 110 may determine the email address associated with the recipient based on information provided either by the recipient using the recipient device 180 or the third party using the third party device 170. The destination address or device may be predetermined based on information stored in interactive interface 120 or dashboard 130.

Sender platform 110 may determine whether the delivery or transmission of the digital advertisement has been triggered. Delivery or transmission of the digital advertisement may be triggered based on various rules, logic and triggers stored in rules engine 150. The logic and triggers stored in rules engine 150 may contain rules regarding when particular digital advertisements should be delivered to a recipient. The logic and triggers may also contain a predetermined set of rules regarding timing and means of delivery of the digital advertisement.

In some embodiments, the transmission or delivery of the digital advertisement may be triggered based on the timing of the product shelving or product delivery. In some embodiments, the delivery of the digital advertisement may also be triggered based on the recipient scanning the product label or a bar code related to the product. The delivery of the digital advertisement may be based on sender or third party preferences, recipient demographics, location, product information, environmental data and other related information.

In some embodiments, the delivery of the digital advertisement may depend on whether the recipient has opted in or out of receiving certain types of product or digital advertisements. The delivery of the digital advertisement may also be customized based on the sender's knowledge of the recipient's preferences for digital advertisement content or categories of content.

In some embodiments, delivery of the digital advertisement may be triggered based on geographic location or geofencing data. For example, delivery may be triggered based on geofencing when sender platform 110 determines that the product or recipient device 180 is in a specific location based on, for example, Global Positioning System (GPS) coordinates of the product and/or recipient device 180 combined within a predetermined or dynamically generated radius around the GPS coordinates. This information may trigger the delivery of a digital advertisement to recipient device 180.

In some embodiments, the delivery of the digital advertisement may be triggered based on proximity between two or more devices, for example, a device connected to the sender platform 110, third party device 170, and recipient device 180. Such devices may include a courier device, a box sensor, a recipient's phone or an item the recipient is wearing (for example, Google Glass). The devices may recognize each other, for example, using short range communication. Once the devices have recognized each other, communication may occur.

The delivery of the digital advertisement may be triggered based on the occurrence of an event. For example, the delivery of the digital advertisement may be triggered by the occurrence of a pre-delivery event, a delivery-point event, a delivery-triggered event, or post-delivery event. A pre-delivery event may include, for example, digital communications between the sender using sender platform 110 and the recipient using recipient device 180 prior to delivery of the product. These communications may comprise interactive data exchange between the sender and the recipient, including, for example, tracking emails, text messages, mobile phone application messages, and wearable computing device messages.

In some embodiments, delivery of the digital advertisement may be triggered based on a delivery-point event which may include, for example, the recipient of a product initiating the collection of either the digital advertisement or other digital communication associated with a product delivered. A delivery-point event may include interactions with the product itself, or may include using the tracking number or other unique product identifier to initiate collection of related digital advertisements.

In some embodiments, the digital advertisement may be delivered based on a delivery-triggered event which may include, for example, initiation of delivery of digital advertisements and related digital communications associated with a product when a delivery event by the sender happens. A delivery-triggered event may be driven, for example, by delivery scans by the sender, GPS geofencing, or other similar means. For example, a digital advertisement may be delivered based on location and delivery information related to a unique product delivery event.

In other embodiments, the delivery of the digital advertisement may be triggered based on a post-delivery event which may include, for example, digital communications between sender and recipient after the product is delivered, or after a pre-determined amount of time has passed since a particular event related to the delivery of the product has occurred. The post-delivery event may include, for example, interactive or two way communications between the sender and the recipient after the product has been delivered.

In some embodiments, the delivery of the digital advertisement may be triggered based on another event, pre-defined or otherwise, that occurs before, during or after delivery of the shipment or product. For example, delivery of the digital advertisement and associated communications may be triggered by a scan by a package delivery scan, on truck scan, or proximity of the package to a specific device such as a Bluetooth enabled recipient device 180.

Sender platform 110 may determine whether the logic and triggers stored in the rules engine 150 need to be updated. For example, sender platform 110 may determine whether the rules, logic or triggers are outdated. Sender platform 110 may also determine whether new sender, recipient and/or third party data necessitates changes in the rules, logic or triggers stored in rules engine 150. In some embodiments, sender platform 110 may determine whether the changes in sender, recipient and/or third party relationships translates to changes in the conditional relationships embodied in the rules, logic or triggers stored in rules engine 150.

Sender platform 110 may update the logic and/or triggers stored in rules engine 150. For example, sender platform 110 may automatically update rules, logic and triggers based on the receipt of new data from the sender, recipient and/or third party. The update may also be triggered by changes in the relationships between the sender, recipient and/or third party, or based on supply chain or product history information. For example, sender platform 110 may add, delete, or update the conditional relationships between one or more rules, logic or triggers stored in rules engine 150. Furthermore, the logic and/or triggers stored in rules engine 150 may be updated, changed or varied based on delivery related data, recipient demographic data, product related data, supply chain data, geolocation or geofencing data, time relative to either delivery or other event, or other similar data.

The logic and triggers may also be finely tuned based on sender or third party targeting mechanism created to target for digital advertisements and offerings to relevant recipients of similar or complementary products.

In Step 240, sender platform 110 may transmit or deliver the digital advertisement to one or more destination devices associated with the recipient. For example, sender platform 110 may transmit or deliver a digital advertisement comprising a digital invoice slip or an interactive web form to any recipient device 180 including a desktop computer, a laptop computer, a personal digital assistant (PDA), a cellular telephone device, a voice over Internet Protocol (VoIP) device, Wi-Fi device, a web-enabled cellular device, watches, eyeglass computer, a wearable computer or other similar microcomputer-based workstation or network device.

In another example, the sender platform 110 may deliver a digital advertisement comprising an API that allows machine-to-machine communications to occur. For example, sender platform 110 may deliver a digital advertisement to or exchange data with any “smart” networked device associated with third party device 170 or recipient device 180. The sender platform 110 may include APIs that allow third party device 170 or recipient device 180 to automatically access the digital advertisement or exchange other data with sender platform.

The digital advertisement may be included in package tracking emails, website tracking updates, text messaging, pop-up messages, or other types of messages that can be delivered to recipient device 180. The digital advertisement and associated digital content may be delivered along with tracking notifications sent in response to the recipient entering the tracking number or scanning a product identifying code. The digital advertisement may be delivered, for example, within tracking applications and other related applications interfaces via APIs.

Sender platform 110 may optimize the digital advertisement delivered based on shipment or product specific information or contextual metadata, such as consignee details, package content details, environmental information, and unstructured data such as comments and pictures provided by sender, recipient or third party.

In some embodiments, sender platform 110 may optimize the digital advertisement delivered based on historical information about the recipient shipping behavior including previous items delivered, frequency of items delivered, previous senders of shipments and similar historical metadata.

In some embodiments, sender platform 110 may optimize the digital advertisement delivered based on marketplace mechanics. For example, the rules may trigger delivery of digital advertisements based on time of day, time of year, sender, recipient, sender location, recipient location, or digital advertisement visibility.

Sender platform 110 may also transmit or delivery other associated information or digital communications. For example, sender platform 110 may deliver metadata related to the link between the product delivered and the digital advertisement. As another example, sender platform 110 may transmit a digital advertisement and allow for interactive communication between the sender, recipient and/or third party.

The logic and triggers may include rules controlling how and when digital advertisements need to be delivered. For example, the third party or sender may customize the type of digital advertisements to be delivered to the customer when a particular product or type of product is contained in a shipment. The third party or sender may also indicate what type of digital advertisement should be delivered based on recipient demographic data such as age, sex, socioeconomic data, and other related information.

In Step 250, sender platform 110 may perform post-delivery processing. For example, sender platform 110 may determine, based on the digital advertisement transmitted or delivered, whether to allow interactive communications between the sender, recipient and/or third party. If the digital advertisement contains an interactive web form or product registration link, sender platform 110 may provide relevant access privileges to recipient device 180. Sender platform 110 may further determine whether the sender preferences include notifications regarding the delivery of the product and/or the digital advertisement.

Sender platform 110 may also send and receive digital communications between a sender, a recipient and/or a third party. For example, Sender platform 110 may notify the sender of the receipt and acceptance of the product and/or digital advertisement by the recipient. Sender platform 110 may direct the recipient to interactive interface 120 or dashboard 130, where the recipient may provide additional information or feedback to the sender. In another example, sender platform 110 may allow the user to complete an interactive web form or survey, collect the survey information, and store it in platform storage 140.

In some embodiments, sender platform 110 may create a digital social network between one or more senders, recipients and/or third parties. The digital social network may be created, for example, by connecting senders, recipients and/or third parties through interactive interface 120 or dashboard 130 of sender platform 110. The digital social network may be based on the digital advertisements or products sent or received by the sender, recipient and/or third party. The digital social network may be customized based on the user preferences of the sender, recipient and/or third party.

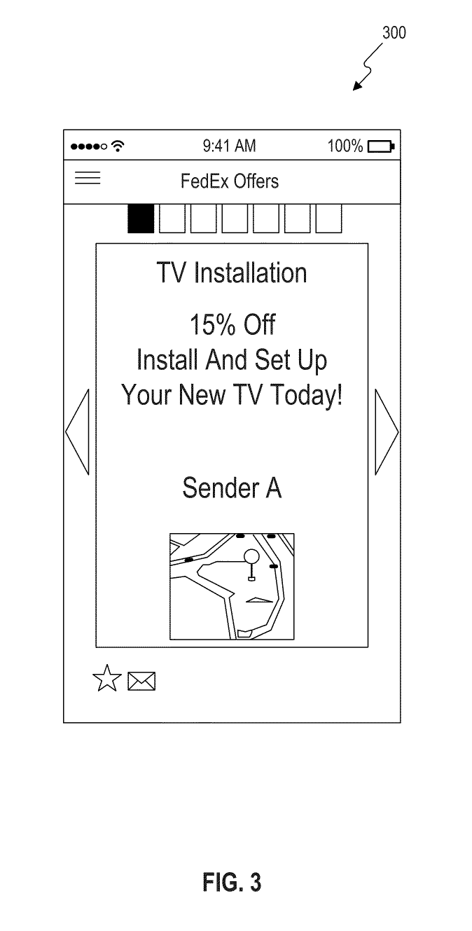

FIG. 3 depicts an exemplary digital advertisement 300 consistent with disclosed embodiments. Digital advertisement 300 may be created and delivered in a delivery ad network. In the example illustrated in FIG. 3, digital advertisement 300 includes a mobile device digital offer for TV installation. The mobile device digital offer may indicate the details of the offer such as promotions being run by sender or third parties located close to the recipient's location. Sender platform 110 may transmit digital advertisement 300 to a destination address associated with a recipient or recipient device 180.

Although FIG. 3 is an example in which digital advertisement 300 is displayed as an offer within a product tracking mobile app used by recipient, digital advertisement 300 may be any kind of targeted digital content such as offers, discounts, marketing communications, product information, warranties and other information matching the product received by the recipient. The digital advertisement may be delivered in package tracking emails, website tracking updates, text messaging, pop-up messages, or other types of messages. Further, the digital advertisement may be sent by the sender or a third party.

In some embodiments, the sender or third party may customize preferences regarding the digital advertisements to be delivered. Further, the digital advertisement may include an interactive web form that allows for real-time communication between the recipient and sender or third party.

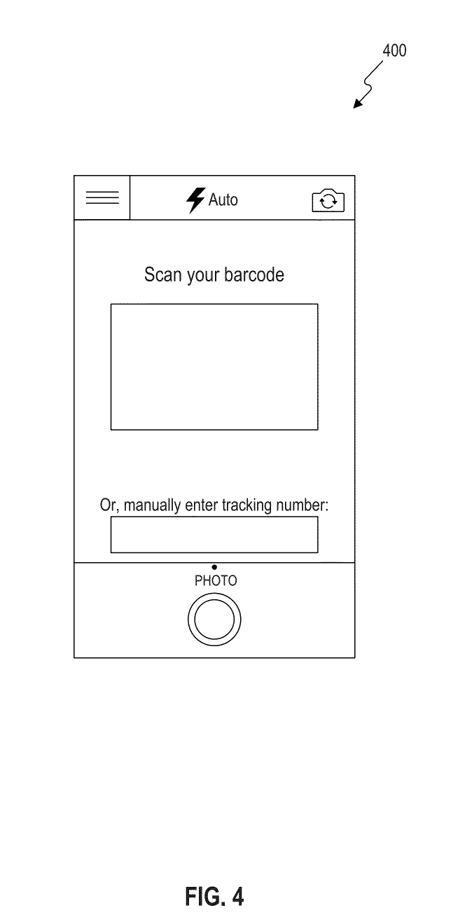

FIG. 4 depicts an exemplary recipient device 400 consistent with disclosed embodiments. Recipient device 400 may be used in a system for creating and delivering digital advertisements in a delivery ad network consistent. As illustrated in FIG. 4, recipient device 400 may include a mobile barcode scanning application.

In some embodiments, the recipient device 400 may allow the recipient to manually enter the tracking number for the product. Further, the scanning of a product or the entry of the tracking number may trigger the delivery of a digital advertisement linked to the product.

The digital advertisement and associated digital content may be delivered along with tracking notifications sent in response to the recipient entering the tracking number or scanning a product identifying code. The digital advertisement may be delivered, for example, within a tracking applications and other related applications interfaces via APIs.

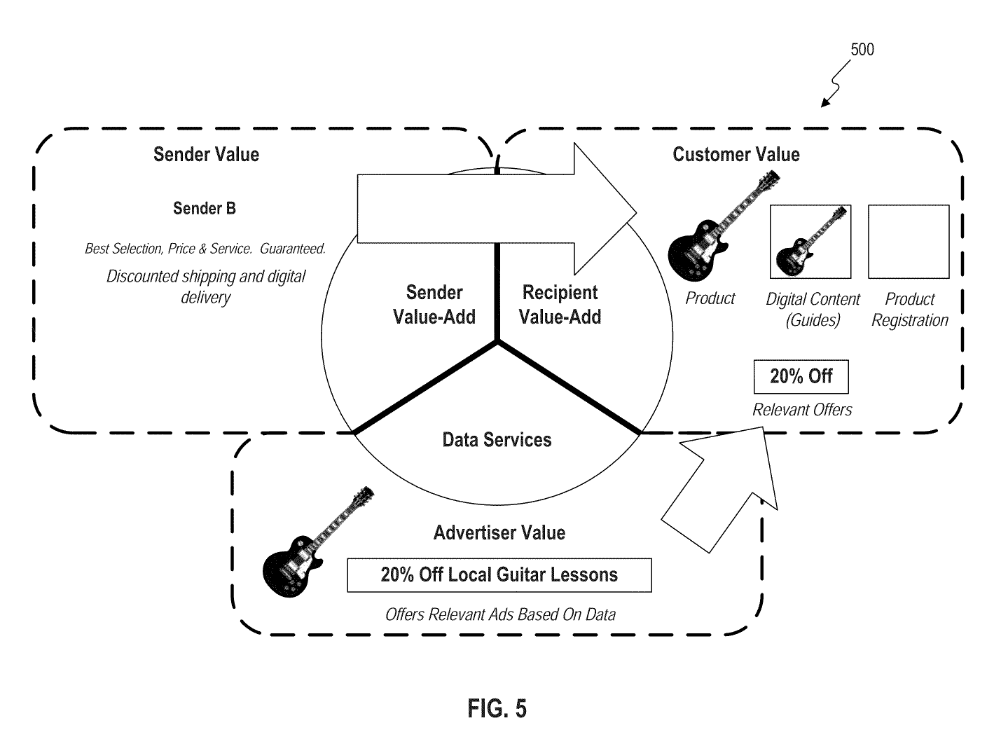

FIG. 5 depicts an exemplary process for creating and delivering digital advertisements in a delivery ad network consistent with disclosed embodiments. As illustrated in FIG. 5, a sender may transmit a product, such as a guitar, to a recipient. Sender platform 110 may establish a link between the product, in this case a guitar, and a digital advertisement such as video guides and product registration forms. The logic and triggers stored in rules engine 150 may trigger delivery of the digital advertisement, in this case video guides and product registration forms, to the recipient device 180.

Sender platform 110 may transmit the digital advertisement in a variety of formats. For example, the digital advertisement may be included in package tracking emails, website tracking updates, text messaging, pop-up messages, or other types of messages. Additionally, the digital advertisement and associated digital content may be transmitted along with tracking notifications sent in response to the recipient entering the tracking number or scanning a product identifying code. The digital advertisement may be delivered, for example, within tracking applications and other related applications interfaces via APIs.

After the digital advertisement is delivered, the recipient may respond to the seller using the product registration form, for example, by clicking on a link included in form or by accessing either interactive interface 120 or dashboard 130.

The sender or third party (such as an advertiser) may supply additional digital advertisements and related digital assets to a recipient based on contextual information provided by sender platform 110. For example, a third party such as a local guitar teacher may offers the recipient a digital advertisement for guitar lessons based on the fact that the recipient received a product such as a guitar, and based on other information supplied by the sender platform 110 such as location, time, customer purchase history or customer demographics.

The sender or a third party may cause sender platform 110 to transmit or deliver the digital advertisement. The sender or third party may customize preferences regarding the digital advertisements to be delivered. Further, the digital advertisement may include an interactive web form that allows for real-time communication between the recipient and sender or third party.

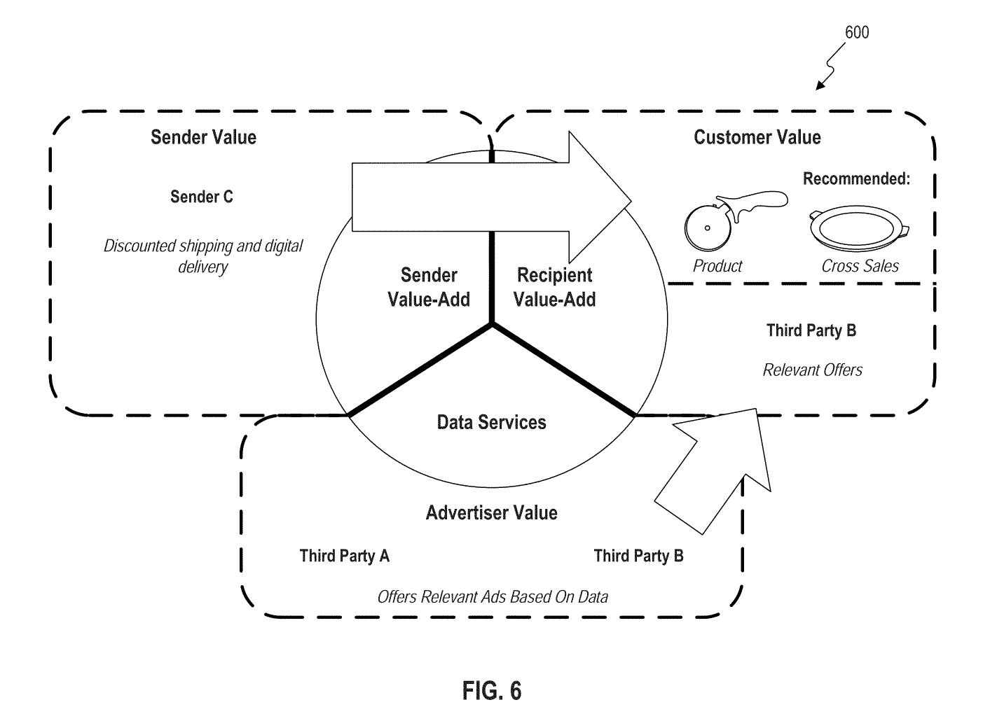

FIG. 6 depicts another exemplary process for creating and delivering digital advertisements in a delivery ad network consistent with disclosed embodiments. As illustrated in FIG. 6, a sender or a third party may transmit a product, such as a pizza pan, to a recipient.

As shown in FIG. 6, sender platform 110 may establish a link between the product, in this case a pizza pan, and a digital advertisement such as a cross sale offer. The logic and triggers stored in rules engine 150 may trigger delivery of the digital advertisement, in this case a cross sale offer, to the recipient device 180. The digital advertisement may be delivered in package tracking emails, website tracking updates, text messaging, pop-up messages, or other types of messages. The digital advertisement and associated digital content may be delivered along with tracking notifications sent in response to the recipient entering the tracking number or scanning a product identifying code. The digital advertisement may be delivered, for example, within tracking applications and other related applications interfaces via APIs.

The sender or third party (such as an advertiser) may supply additional digital advertisements and related digital assets to a recipient based on contextual information provided by sender platform 110. For example, a third party such as a local pizza restaurant may offers the recipient a digital advertisement for discounts on pizzas based on the fact that the recipient received a product such as a pizza pan, and based on other information supplied by the sender platform 110 such as location, time, customer purchase history or customer demographics.

The digital advertisement may be sent by either the sender or a third party. The sender or third party may customize preferences regarding the digital advertisements to be delivered. Further, the digital advertisement may include an interactive web form that allows for real-time communication between the recipient and sender or third party.

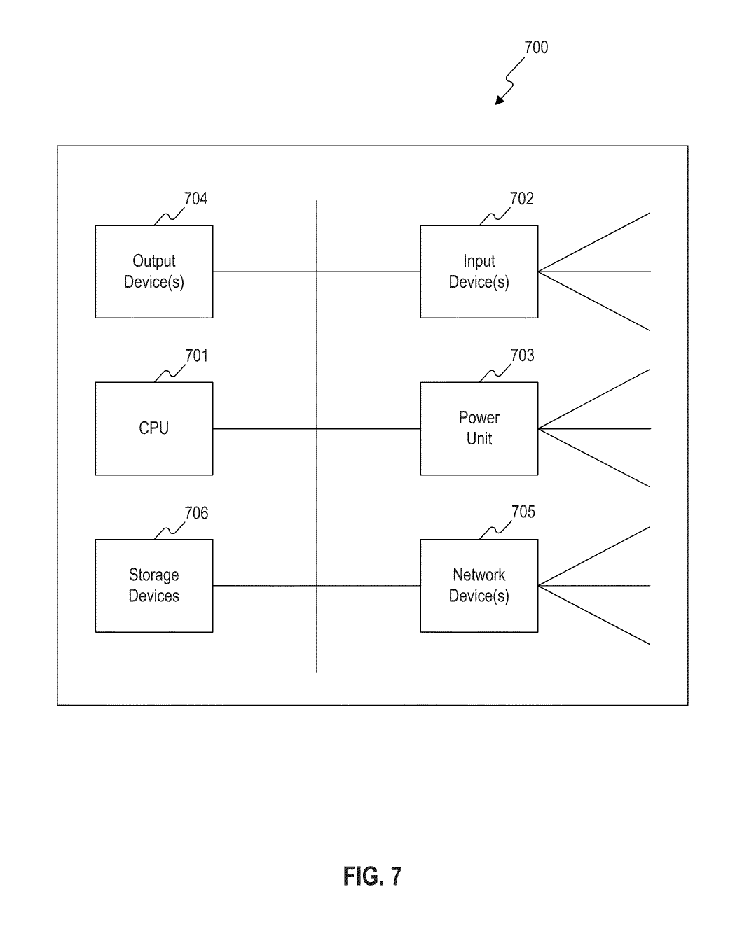

FIG. 7 is an exemplary computing device 700, consistent with disclosed embodiments. In some embodiments, the computing device 700 may correspond to any of the components of system 100, including sender platform 100, third party device 170, or recipient device 180. Although the description may refer to terms commonly used in describing particular computer systems, such as a personal computer, the description and concepts equally apply to other computer systems, such as network computers, workstations, and mainframe computers having architectures dissimilar to FIG. 7.

As shown in FIG. 7, exemplary computer device 700 may include one or more central processing units 701 for managing and processing data and operations consistent with the disclosed embodiments. CPU 701 may be configured to process data, execute software instructions stored in memory, and transmit data between the other components of device 700. For example, CPU 701 may be implemented as a conventional microprocessor, a mobile microprocessor, a desktop microprocessor, a server microprocessor, or any other type of processor.

In some embodiments, computer device 700 may also include one or more input devices 702, which are configured to receive input from a user, other computers, other devices, or other modules. Input devices 702 may include, but are not limited to, keyboards, mice, trackballs, trackpads, scanners, cameras, external storage or information devices, and other devices, which connect via Universal Serial Bus (USB), serial, parallel, infrared, wireless, wired, or other connections.

Computer device 700 may also include one or more power units 703, which may supply operating power to computer device 700 and its components from one or more sources. The power units 703 may include rechargeable batteries, such as lithium-ion or nickel-cadmium batteries, which may be charged using power from a variety of sources such as a photovoltaic device, a wall outlet, a capacitor, or a solar cell. The power units 703 may be wirelessly chargeable.

Computer device 700 may include one or more output devices 704 that may be configured to transmit data to users and/or modules or devices. Such modules or devices may include, but are not limited to, computer monitors, televisions, screens, interface ports, projectors, printers, plotters, and other recording/displaying devices which connect via wired or wireless connections.

Computer device 700 may also include one or more network devices 705. Network device 705 may be configured to allow computer device 700 to connect to and exchange information with one or more networks, such as the Internet, a local area network, a wide area network, a cellular network, a wireless network, or any other type of network. Network device 705 may be implemented as a wired network adapter, a wireless network adapter, an infrared network adapter, a cellular or satellite network adapter, or any other type of network adapter.

Computer device 700 may also include one or more storage devices 706. Storage devices 706 may be comprise optical, magnetic, electronic, or any other type of memory configured to store information. Storage devices 706 may store, for example, data, instructions, programs/applications, operating systems, or a combination of these.

While FIG. 7 illustrates the components of device 700 as connected in a “bus” configuration, other connections and configurations are possible. Additionally, while the devices in FIG. 7 are represented in a singular form, in some embodiments, each of the devices in FIG. 7 may be omitted, duplicated, substituted, or more than one of each of the devices in FIG. 7 may be implemented.

Operation of computer system 700 may be controlled and coordinated by operating system software. The operating system may control allocation of system resources and performs tasks, such as memory management, process scheduling, networking, and services, among other things.

Various embodiments have been described with reference to the accompanying drawings and embodiments. It will, however, be evident that various modifications and changes may be made thereto, and additional embodiments may be implemented, without departing from the present disclosure. The specification and drawings are accordingly to be regarded in an illustrative rather than restrictive sense.

For example, advantageous results may still be achieved if steps of the disclosed methods were performed in a different order and/or if components in the disclosed systems were combined in a different manner and/or replaced or supplemented by other components. Advantageous results may still be achieved if values or data were different than explicitly disclosed. Other implementations are also within the scope of the present disclosure.

Furthermore, although exemplary embodiments have been described as being associated with data stored in memory and other storage mediums, one skilled in the art will appreciate that these aspects can also be stored on or read from other types of computer-readable media, such as secondary storage devices, hard disks, floppy disks, a CD-ROM, or other forms of RAM or ROM. Further, the steps of the disclosed methods may be modified in any manner, including by reordering steps and/or inserting or deleting steps, without departing from the principles of the disclosed embodiments.

It is intended, therefore, that the specification be considered as exemplary only, with a true scope and spirit being indicated by the following claims and their full scope of equivalents.

What is claimed is:

1. A computer-implemented method for creating and delivering digital advertisements in a delivery ad network, comprising:
receiving, by a processor, a digital advertisement, wherein the digital advertisement includes data associated with a product;
linking, by the processor, the digital advertisement to the product, wherein the linking includes associating a unique identifier associated with the digital advertisement to a unique identifier associated with the product;
preparing, by the processor, the digital advertisement for delivery, wherein the preparation includes determining a destination device associated with a user; and
transmitting, by the processor, the digital advertisement to the destination device associated with the user, wherein the transmission is triggered by a predetermined set of rules.

2. The method as recited in claim 1, further comprising:
transmitting to the user, by the processor, metadata associated with the digital advertisement and the product; and
performing by the processor, post-delivery processing, wherein the post-delivery processing includes receiving information from the user based on at least one of the digital advertisement, the product, the sender, or the third party.

3. The method as recited in claim 1, wherein the linking of the digital advertisement to the product further comprises selecting a pre-determined type of digital advertisement associated with a pre-determined type of product.

4. The method as recited in claim 1, wherein the predetermined set of rules are based on at-least one of: a pre-delivery event, a delivery-point event, a delivery-triggered event, or a post-delivery event.

5. The method as recited in claim 1, wherein the predetermined set of rules are based on at-least one of: market or demand based characteristics, delivery characteristics, location, recipient demographics, shipping history, product details, and or digital advertisement placement visibility.

6. The method as recited in claim 1, wherein the digital advertisement includes an interactive form.

7. The method as recited in claim 1, wherein the digital advertisement includes an API.

8. A system for creating and delivering digital advertisements in a delivery ad network comprising:
at least one processor;
a memory device storing instructions executable by the at least one processor to perform operations of:
receiving a digital advertisement, wherein the digital advertisement includes data associated with a product;
linking the digital advertisement to the product, wherein the linking includes associating a unique identifier associated with the digital advertisement to a unique identifier associated with the product;
preparing the digital advertisement for delivery, wherein the preparation includes determining a destination device associated with a user; and
transmitting the digital advertisement to the destination device associated with the user, wherein the transmission is triggered by a predetermined set of rules.

9. The system of claim 8, wherein the memory device further stores instructions executable by the at least one processor, to perform operations of:
transmitting, to the user, metadata associated with the digital advertisement and the product; and
performing post-delivery processing, wherein the processing includes collecting information from the user based on at least one of the digital advertisement, the product, the sender, or the third party.

10. The system of claim 8, wherein the linking of the digital advertisement to the product further comprises selecting a pre-determined type of digital advertisement associated with a pre-determined type of product.

11. The system of claim 8, wherein the predetermined set of rules are based on at-least one of: a pre-delivery event, a delivery-point event, a delivery-triggered event, or a post-delivery event.

12. The system of claim 8, wherein the predetermined set of rules are based on at-least one of: market or demand based characteristics, delivery characteristics, location, recipient demographics, shipping history, product details, and or digital advertisement placement visibility.

13. The system of claim 8, wherein the digital advertisement includes an interactive form.

14. The system of claim 8, wherein the digital advertisement includes an API.

15. A non-transitory computer readable medium storing instructions that, when executed by at least one processor, cause the at least one processor to execute a computer-implemented method for creating and delivering digital advertisements in a delivery ad network, the method comprising:
receiving a digital advertisement, wherein the digital advertisement includes data associated with a product;
linking the digital advertisement to the product, wherein the linking includes associating a unique identifier associated with the digital advertisement to a unique identifier associated with the product;
preparing the digital advertisement for delivery, wherein the preparation includes determining a destination device associated with a user; and
transmitting the digital advertisement to the destination device associated with the user, wherein the transmission is triggered by a predetermined set of rules.

16. The non-transitory computer readable medium of claim 15, the method further comprising:
transmitting to the user metadata associated with the digital advertisement and the product; and
performing post-delivery processing, wherein the processing includes collecting information from the user based on at least one of the digital advertisement, the product, the sender, or the third party.

17. The non-transitory computer readable medium of claim 15, wherein the linking of the digital advertisement to the product further comprises selecting a pre-determined type of digital advertisement associated with a pre-determined type of product.

18. The non-transitory computer readable medium of claim 15, wherein the predetermined set of rules are based on at-least one of: a pre-delivery event, a delivery-point event, a delivery-triggered event, or a post-delivery event.

19. The non-transitory computer readable medium of claim 15, wherein the predetermined set of rules are based on at-least one of: market or demand based characteristics, delivery characteristics, location, recipient demographics, shipping history, product details, and or digital advertisement placement visibility.

20. The non-transitory computer readable medium of claim 15, wherein the digital advertisement includes an interactive form.

21. The non-transitory computer readable medium of claim 15, wherein the digital advertisement includes an API.
